(19) United States
(12) Patent Application Publication
(10) Pub. No.: US 2024/0024856 A1
(43) Pub. Date: Jan. 25, 2024

(54) OXYGEN STORAGE CAPACITY ENHANCED COMPOSITIONS

(71) Applicant: Neo Performance Materials (Singapore) Pte. Ltd., Singapore (SG)

(72) Inventors: Szu Hwee NG, Singapore (SG); Suzi DENG, Singapore (SG); Perlyn KOH, Singapore (SG); Steffi TAN, Singapore (SG)

(73) Assignee: Neo Performance Materials (Singapore) Pte. Ltd., Singapore (SG)

(21) Appl. No.: 18/041,177

(22) PCT Filed: Jul. 22, 2021
(86) PCT No.: PCT/IB2021/000511

§ 371 Date: Feb. 9, 2023

Related U.S. Application Data
(60) Provisional application No. 63/064,610, filed on Aug. 12, 2020.

(51) Int. Cl. B01J 23/10; B01J 21/06; B01J 37/08; B01J 37/04; B01J 37/03; B01J 35/10

(52) U.S. Cl. CPC B01J 23/10; B01J 21/066; B01J 37/082; B01J 37/04; B01J 37/031; B01J 35/1004

(57) ABSTRACT

Disclosed herein are compositions having enhanced oxygen storage capacity (OSC). The OSC enhanced compositions contain cerium, zirconium, lanthanum, and neodymium, and a dopant element selected from the group consisting of Ti, Mn, Fe, Co, Cu, Zn, Ga, Ge, Ta, W, Mo, Nb, In, Sn, Ba, and mixtures thereof. In certain embodiments, these compositions contain two dopants. In certain embodiments of these compositions, the compositions comprising cerium, zirconium, lanthanum, and neodymium and one or more dopant elements have an OSC after aging at 1000° C. for 10 hours which is improved by 1 to 50%, compared to an undoped composition comprising cerium, zirconium, lanthanum, and neodymium. Aging can be conducted in an air environment. Further disclosed are processes of producing these compositions having enhanced oxygen storage capacity (OSC). The compositions can be used as a catalyst.

This application relates to compositions having enhanced oxygen storage capacity (OSC), processes of producing these compositions, and uses for same. The OSC enhanced compositions disclosed herein contain cerium, zirconium, lanthanum, and neodymium, and one or more dopants, wherein the dopant is an element selected from the group consisting of Ti, Mn, Fe, Co, Cu, Zn, Ga, Ge, Ta, W, Mo, Nb, In, Sn, Ba, and mixtures thereof.

### INTRODUCTION

Oxygen storage/release (OSC) capacity is an important feature for many catalysts. For example, catalysts for purifying vehicle exhaust gas are composed of catalytic materials that have the properties of absorbing oxygen under the oxidizing atmosphere and desorbing oxygen under the reducing atmosphere. With this oxygen absorbing and desorbing capability, the materials purify noxious components in exhaust gas such as hydrocarbons, carbon monoxide, and nitrogen oxides at excellent efficiency. These catalysts are able to oxidize carbon monoxide and hydrocarbons present in exhaust gases and also reduce nitrogen oxides present in the exhaust gases. As such, these catalytic materials are used mainly for catalytic converters in vehicles to purify exhaust gases.

In general, the catalytic material is required to have a sufficiently large specific surface area and a sufficiently high oxygen absorbing and desorbing capability, even at elevated temperatures.

There remains a need for catalytic materials having higher thermal stability and oxygen absorbing and desorbing capability.

### SUMMARY

As disclosed herein, the present compositions having enhanced OSC comprise cerium, zirconium, lanthanum, and neodymium, and a dopant, wherein the dopant is selected from the group consisting of Ti, Mn, Fe, Co, Cu, Zn, Ga, Ge, Ta, W, Mo, Nb, In, Sn, Ba, and mixtures thereof.

In some embodiments, the compositions consist essentially of cerium, zirconium, lanthanum, and neodymium, and a dopant, wherein the dopant is selected from the group consisting of Ti, Mn, Fe, Co, Cu, Zn, Ga, Ge, Ta, W, Mo, Nb, In, Sn, Ba, and mixtures thereof.

As further disclosed herein the compositions consist of cerium, zirconium, lanthanum, neodymium, one or more dopant elements, and less than 0.5% by weight other elements, wherein the dopant elements are Ti, Mn, Fe, Co, Cu, Zn, Ga, Ge, Ta, W, Mo, Nb, In, Sn, Ba, and mixtures thereof and the other elements are any elements that are not Ce, Zr, La, Nd, Ti, Mn, Fe, Co, Cu, Zn, Ga, Ge, Ta, W, Mo, Nb, In, Sn, or Ba.

In certain embodiments of these compositions, the dopants are present in the composition in an amount of about 0.1-10 wt % of composition and in certain embodiments, there are two dopants present. In particular embodiments of these compositions, there are two dopants present and the dopants are Sn and Nb. In other embodiments of these compositions, there are two dopants present and the dopants are Nb and In. In further embodiments of these compositions, there are two dopants present and the dopants are Sn and Ba.

The process as disclosed herein of producing a composition comprising cerium, zirconium, lanthanum, and neodymium and one or more dopants comprises the steps of: (a) mixing Zr, La, Nd, and Ce salts and dopant X in water to provide a mixture; (b) adding the mixture to an ammonia water solution to form a precipitate; and (c) calcining the precipitate. Dopant X is selected from the group consisting of Ti, Mn, Fe, Co, Cu, Zn, Ga, Ge, Ta, W, Mo, Nb, In, Sn, Ba, and mixtures thereof. In certain embodiments, dopant X is two elements selected from Ti, Mn, Fe, Co, Cu, Zn, Ga, Ge, Ta, W, Mo, Nb, In, Sn and Ba. The composition produced by this process may be used as a catalyst and exhibits enhanced OSC.

In certain embodiments of these compositions, the compositions comprising cerium, zirconium, lanthanum, and neodymium and one or more dopant elements have an OSC after aging at 1000° C. for 10 hours which is improved by about 1 to 50%, compared to an undoped composition comprising cerium, zirconium, lanthanum, and neodymium, and in particular of these embodiments the OSC is improved by about 1 to 35%. The aging can be done in an oxidizing environment in a reducing environment or in a cyclic reducing-oxidizing environment.

### BRIEF DESCRIPTION OF THE DRAWINGS

FIG. 1 illustrates a flowchart of an embodiment of the process of making OSC enhanced materials as disclosed herein.

FIG. 2 is a graph illustrating the effects of doping with Sn, Nb, and a combination of Sn and Nb on surface area and TPR hydrogen consumption.

FIG. 3 is a graph illustrating the effects of doping with Sn, Nb, and a combination of Sn and Nb on H₂-TPR profiles.

FIG. 4 is a graph illustrating the effects of varying dopants including Sn and Nb (Sn+X/X+Nb) on SSA and TPR hydrogen consumption.

FIG. 5 is a graph illustrating the effects of varying dopants including Sn and Nb (Sn+X/X+Nb) on H₂-TPR profiles.

FIG. 6A includes XRD of undoped compositions, with air vs CO/O₂ aging (1000° C. for 10 hours and 1100° C. for 10 hours).

FIG. 6B includes XRD of Sn and Nb doped compositions, with air vs CO/O₂ aging (1000° C. for 10 hours and 1100° C. for 10 hours).

FIG. 6C includes XRD of Sn and Ba doped compositions, with air vs CO/O₂ aging (1000° C. for 10 hours and 1100° C. for 10 hours).

FIG. 6D includes XRD of Sn and Fe doped compositions, with air vs CO/O₂ aging (1000° C. for 10 hours and 1100° C. for 10 hours).

FIG. 7A includes XRD of Sn and Ti doped compositions, with air vs CO/O₂ aging (1000° C. for 10 hours and 1100° C. for 10 hours).

FIG. 7B includes XRD of Sn and Mn doped compositions, with air vs CO/O₂ aging (1000° C. for 10 hours and 1100° C. for 10 hours).

FIG. 7C includes XRD of In and Nb doped compositions, with air vs CO/O₂ aging (1000° C. for 10 hours and 1100° C. for 10 hours).

### DETAILED DESCRIPTION

Before the compositions having enhanced oxygen storage capacity (OSC) and processes are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” include typical experimental variances. As used herein, the term “about” means within a statistically meaningful range of a value, such as a stated particle size, concentration range, time frame, molecular weight, temperature, or pH. Such a range can be within an order of magnitude, typically within 10%, and more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

As used herein “elements” are chemical elements.

The present application relates to compositions having enhanced oxygen storage capacity (OSC). These compositions contain cerium, zirconium, lanthanum, and neodymium, and one or more dopants. The dopants are elements other than rare earth elements. In certain embodiments, the dopants are elements selected from Ti, Mn, Fe, Co, Cu, Zn, Ga, Ge, Ta, W, Mo, Nb, In, Sn, Ba, and mixtures thereof. Importantly, these compositions maintain specific surface area (SSA) similar to or improved over an undoped composition, while also exhibiting an increased OSC.

These compositions have advantageous properties for use in catalysis as a catalyst or as part of a catalyst system. The catalysts are used in vehicles to purify exhaust gases.

In certain embodiments of these compositions, the compositions comprising cerium, zirconium, lanthanum, and neodymium and one or more dopant elements have an OSC after aging at 1000° C. for 10 hours which is improved by about 1 to 50%, compared to an undoped composition comprising cerium, zirconium, lanthanum, and neodymium, and in particular of these embodiments the OSC is improved by about 1 to 35%. In particular embodiments of these compositions, the composition has an OSC after aging at 1000° C. for 10 hours which is improved by about 1 to 30% or about 10 to 30%, compared to an undoped composition comprising cerium, zirconium, lanthanum, and neodymium. The OSC is measured using H₂ temperature programmed reduction (See example 5 below). The improvements are determined based on either lower peak reduction temperatures (PRT) or higher H₂ consumption.

The aging can be done in an oxidizing environment, a reducing environment, or a cyclic oxidizing-reducing environment. An oxizing environment can be any environment that contains an oxidizer. For example, an oxidizing environment is air. A reducing environment is one that is depleted in an oxidizer component. A cyclic oxidizing-reducing environment is one that the environment periodically changes from oxidizing to reducing. For example, air can be introduced over the material for one minute, whereas, the following minute the environment is changed over to CO; this cyclic process continuing for the required time.

In certain embodiments, the composition comprises cerium, zirconium, lanthanum, and neodymium, and one or more dopants, wherein the dopants are selected from Ti, Mn, Fe, Co, Cu, Zn, Ga, Ge, Ta, W, Mo, Nb, In, Sn, and Ba.

In other embodiments, the composition consists essentially of cerium, zirconium, lanthanum, and neodymium, and one or more dopants, wherein the dopants are selected from Ti, Mn, Fe, Co, Cu, Zn, Ga, Ge, Ta, W, Mo, Nb, In, Sn, and Ba.

In further embodiments, the composition consists of cerium, zirconium, lanthanum, neodymium, one or more dopant elements, and less than about 0.5% by weight other elements, wherein the dopant elements are Ti, Mn, Fe, Co, Cu, Zn, Ga, Ge, Ta, W, Mo, Nb, In, Sn, and Ba, and the other elements are any elements that are not Ce, Zr, La, Nd, Ti, Mn, Fe, Co, Cu, Zn, Ga, Ge, Ta, W, Mo, Nb, In, Sn, or Ba.

In certain of these compositions, the ratio of CeO₂/ZrO₂/La₂O₃/Nd₂O₃ can be approximately 15-25 wt %/65-75 wt %/0.5-3 wt %/2-8 wt %. In one example embodiment of these compositions, the ratio of CeO₂/ZrO₂/La₂O₃/Nd₂O₃ can be approximately 20.8 wt %/72.2 wt %/1.7 wt %/5.3 wt %. All compositions are referenced on an oxide equivalent basis.

Further, in these compositions, the dopants can be present in the composition in an amount of about 0.1-10 wt % of the composition, and in certain embodiments, the dopants can be present in the composition in an amount of about 1-10 wt % of composition. In some embodiments, the dopants can be present in an amount of about 0.1 to 5 wt % of the composition. Also in these compositions and in all of the embodiments, other elements can be present in an amount of less than about 0.5% by weight.

In certain embodiments, the compositions as disclosed herein can contain, one, two, three, four, five, or six types of dopants, and in some instances, two, three, or four types of dopants. In some embodiments, the compositions contain two or three types of dopants, and in some instances two types of dopants.

The dopant element can be introduced into the composition through any suitable compound in which the dopant element is the cation. For example, a first dopant can introduced into the composition by a compound selected from the group consisting of SnCl₄ anhydrous (fuming), SnCl₄·5H₂O, SnCl₂·2H₂O, SnC₂O₄, In(NO₃)₃, and mixtures thereof and a second dopant can introduced into the composition by a compound selected the group consisting of NbCl₅, Nb(O)(C₂O₄)₂NH₄, Ba(CH₃COO)₂, ammonium iron (III) citrate, ammonium iron (III) oxalate, iron (II) oxalate, FeCl₂, FeCl₃, iron (III) nitrate, iron (III) acetylacetonate, manganese (II) acetate, ammonium titanyl (IV) oxalate, and mixtures thereof.

In some embodiments, the compositions include two dopants, which are Sn and Nb. The certain of these embodiments, the ratio of Sn to Nb is about 2.5 to 0.1 and in certain embodiments, the ratio of Sn to Nb is about 1.5 to 0.2. In certain embodiments, the Sn dopant can be introduced into the compositions by tin oxalate and the Nb dopant can be introduced into the composition by niobium ammonium oxalate.

In other embodiments, the compositions include two dopants, wherein the dopants are Sn and Fe. In other embodiments, the compositions include two dopants, wherein the dopants are Sn and Ba. In yet other embodiments, the compositions include two dopants, wherein the dopants are Nb and In.

The compositions having enhanced OSC as disclosed herein are made by a process comprising: (a) mixing Zr, La, Nd, and Ce salts and dopant(s) X in water, to provide a mixture; (b) adding the mixture to an ammonia water solution to form a precipitate; and (c) calcining the precipitate to provide the compositions as described herein. In some embodiments of this process, two dopant X are used.

The starting Zr, La, Nd, and Ce salts are water soluble and in the process are dissolved in water. The Zr, La, Nd, and Ce soluble salts can be nitrates, chlorides, and the like. For example, the Ce salt can be a nitrate. The cerium salt can be of Ce(III) or Ce(IV) oxidation state. The starting Ce nitrate is also dissolved in water, as are the one or more dopant X.

In one embodiment the Zr, La, and Nd salts can be nitrates. In one embodiment, the Ce salt is also a nitrate.

The dopant X is an element selected from Ti, Mn, Fe, Co, Cu, Zn, Ga, Ge, Ta, W, Mo, Nb, In, Sn, Ba, and mixtures thereof.

The one or more dopant element can be introduced into the composition through any suitable compound in which the dopant element is the cation. For example, a first dopant X can introduced into the composition by a compound selected from the group consisting of SnCl₄ anhydrous (fuming), SnCl₄·5H₂O, SnCl₂·2H₂O, SnC₂O₄, In(NO₃)₃, and mixtures thereof and a second dopant X can introduced into the composition by a compound selected the group consisting of NbCl₅, Nb(O)(C₂O₄)₂NH₄, Ba(CH₃COO)₂, ammonium iron (III) citrate, ammonium iron (III) oxalate, iron (II) oxalate, FeCl₂, FeCl₃, iron (III) nitrate, iron (III) acetylacetonate, manganese (II) acetate, ammonium titanyl (IV) oxalate, and mixtures thereof.

The order of addition of adding Zr, La, and Nd salts, Ce salt, and one or more dopant X in water, to provide the mixture of step (a) is not important and any addition order may be utilized or all may be added together simultaneously. Further, the rate of addition is not important. In some embodiments, in step (a) the ceric nitrate in water is added to the ZR, La, and Nd nitrates; a first dopant X is added, and then a second dopant X is added to provide the mixture. After addition and stirring, the mixture of step (a) may have an oxide concentration of approximately 20 g/L to 150 g/L and in certain embodiments approximately 100 g/L.

The precipitate obtained in step (b) may be washed with water to achieve a selected wash-water conductivity before calcining. The calcining process can be conducted at a temperature ranging from about 400° C. to 1100° C. and for from about 0.25 to 24 hours. In certain instances, the calcining process can be conducted at a temperature from about 650° C. to 850° C. and for 3 to 7 hours. The calcining process provides the composition as disclosed herein having enhanced OSC.

Calcining can be conducted in any appropriate furnace and environment, including but not limited to, oxidizing, reducing, hydrothermal, or inert. In some embodiments, an oxidizing environment is preferred. A tubular furnace can be used. By virtue of its tubular design, a tube furnace allows better airflow for more thorough treatment.

The compositions made by the process exhibit X-ray diffractograms that are devoid of extraneous peaks, other than those of the cubic or any of the tetragonal phases.

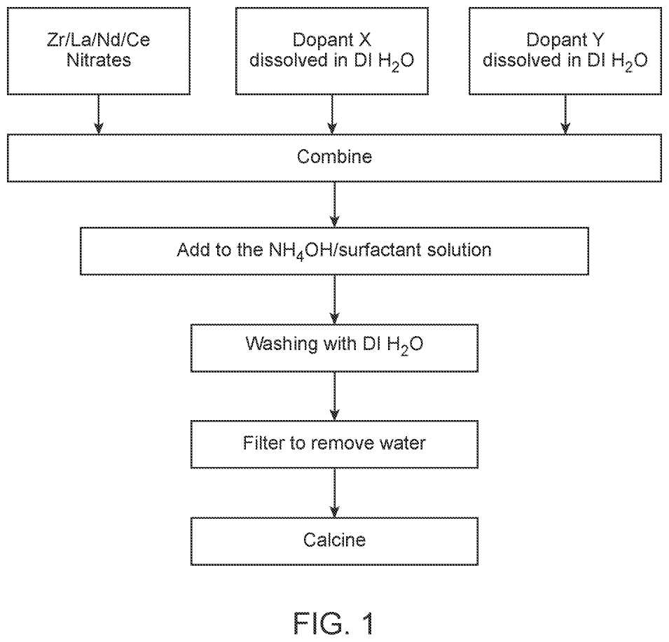

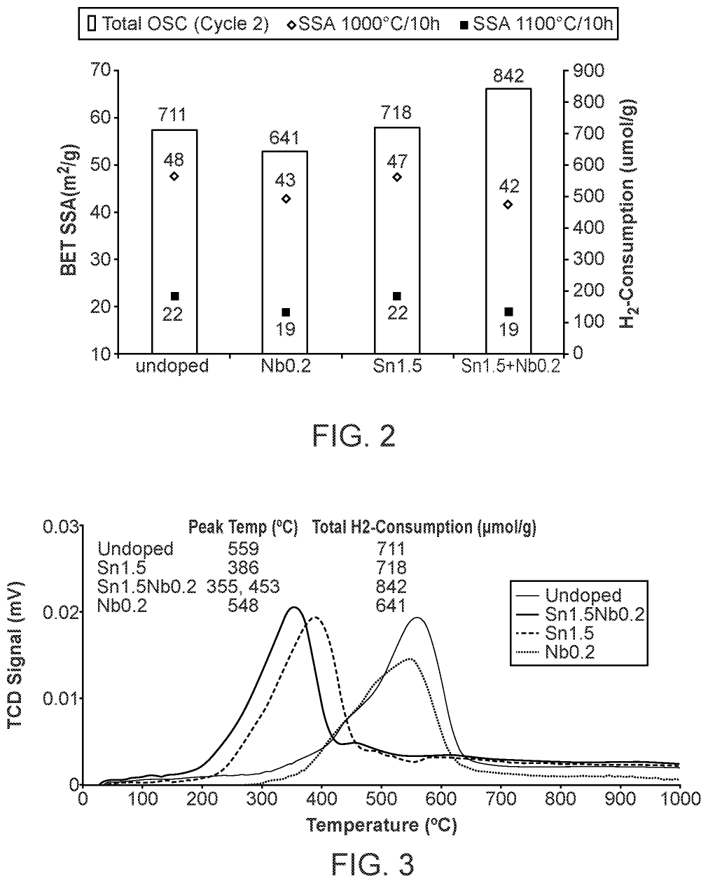

FIG. 1 is a flow chart for an embodiment of the process of making OSC enhanced materials as disclosed herein.

The compositions as disclosed herein were made and tested for Total OSC and surface area after aging at 1000° C. for 10 hours in an oxidizing environment and after aging at 1100° C. for hours in an oxidizing environment. Total OSC is equivalent to H₂ consumption. Example of how it is measured is in example 5 below. Surface area is measured using a Micromeritics Tristar II 3020 instrument. The B.E.T. equation was applied to the relative pressure (P/Po) data points between 0.05 and 0.30 to calculate the surface area.

It is important for the doped compositions to have temperature stable surface areas similar or improved when compared to an undoped composition comprising cerium, zirconium, lanthanum, and neodymium, while exhibiting improved OSC.

In some embodiments, the doped compositions have surface areas after aging at 1000° C. for 10 hours in an oxidizing environment which is maintained in the range of approximately 50% to 100% of that for the undoped composition comprising cerium, zirconium, lanthanum, and neodymium. In certain embodiments, the doped compositions have surface areas after aging at 1000° C. for 10 hours in an oxidizing environment which is improved over that of the undoped composition comprising cerium, zirconium, lanthanum, and neodymium, and thus, the surface areas after aging at 1000° C. for 10 hours in an oxidizing environment is more than 100% of that for the undoped composition. In certain embodiments the doped compositions as disclosed herein have surface areas after aging at 1000° C. for 10 hours in an oxidizing environment which is maintained in the range of approximately 85% to 100% or more of that for the undoped composition comprising cerium, zirconium, lanthanum, and neodymium.

In other embodiments, the doped compositions as disclosed herein have surface areas after aging at 1100° C. for 10 hours in an oxidizing environment which is maintained in the range of approximately 60% to 100% of that for the undoped composition comprising cerium, zirconium, lanthanum, and neodymium. In certain embodiments, the doped compositions have surface areas after aging at 1100° C. for 10 hours in an oxidizing environment which is improved over that of the undoped composition comprising cerium, zirconium, lanthanum, and neodymium, and thus, the surface areas after aging at 1100° C. for 10 hours in an oxidizing environment is more than 100% of that for the undoped composition.

In certain embodiments, compositions comprising cerium, zirconium, lanthanum, and neodymium doped with Sn and Nb exhibit a surface area that is similar to an otherwise identical undoped composition. In other embodiments, compositions comprising cerium, zirconium, lanthanum, and neodymium doped with Sn and Ba exhibit a surface area that is similar to an otherwise identical undoped composition. In certain embodiments, compositions comprising cerium, zirconium, lanthanum, and neodymium doped with Sn and Ba exhibit a surface area that is improved (more than 100%) compared to an otherwise identical undoped composition.

In further embodiments, compositions comprising cerium, zirconium, lanthanum, and neodymium doped with Sn and Fe and compositions comprising cerium, zirconium, lanthanum, and neodymium doped with Sn and Ti exhibit surface area that is 50% to 100% of that of an undoped composition. In certain embodiments, compositions comprising cerium, zirconium, lanthanum, and neodymium doped with Sn and Fe and compositions comprising cerium, zirconium, lanthanum, and neodymium doped with Sn and Ti exhibit surface area that is improved (more than 100%) comparted to an otherwise identical undoped composition.

The doped compositions also exhibit an increased OSC. In certain embodiments, compositions comprising cerium, zirconium, lanthanum, and neodymium doped with two or more elements exhibit a synergistically increased OSC. As used herein, “synergistic” means an increase that is more than additive of the individual dopants in compositions alone rather than when used together.

In certain embodiments of these compositions, the compositions comprising cerium, zirconium, lanthanum, and neodymium and one or more dopant elements have an OSC after aging at 1000° C. for 10 hours in an oxidizing environment which is improved by about 1 to 50%, compared to an undoped composition comprising cerium, zirconium, lanthanum, and neodymium, and in particular of these embodiments the OSC is improved by about 1 to 35%. In particular embodiments of these compositions, the composition has an OSC after aging at 1000° C. for 10 hours in an oxidizing environment which is improved by about 1 to 30% or about 10 to 30%, compared to an undoped composition comprising cerium, zirconium, lanthanum, and neodymium.

In certain embodiments, compositions comprising cerium, zirconium, lanthanum, and neodymium doped with Sn and Nb have an OSC after aging at 1000° C. for 10 hour in an oxidizing environment which is improved by approximately 18%, compared to an undoped composition comprising cerium, zirconium, lanthanum, and neodymium. In other embodiments, compositions comprising cerium, zirconium, lanthanum, and neodymium doped with Sn and Ba have an OSC after aging at 1000° C. for 10 hours in an oxidizing environment which is improved by approximately 30%, compared to an undoped composition comprising cerium, zirconium, lanthanum, and neodymium. In further embodiments, compositions comprising cerium, zirconium, lanthanum, and neodymium doped with Sn and Fe have an OSC after aging at 1000° C. for 10 hours in an oxidizing environment which is improved by approximately 25%, compared to an undoped composition comprising cerium, zirconium, lanthanum, and neodymium. In yet further embodiments, compositions comprising cerium, zirconium, lanthanum, and neodymium doped with Sn and Ti have an OSC after aging at 1000° C. for 10 hours in an oxidizing environment which is improved by approximately 16%, compared to an undoped composition comprising cerium, zirconium, lanthanum, and neodymium.

In embodiments, compositions comprising cerium, zirconium, lanthanum, and neodymium doped with Sn and Nb exhibit an increase of OSC of approximately 18%, in comparison to an undoped composition. In addition, this increase is in contrast to compositions comprising cerium, zirconium, lanthanum, and neodymium doped with either Sn or Nb alone, which have similar OSC in comparison to the undoped composition. As such, compositions comprising cerium, zirconium, lanthanum, and neodymium doped with Sn and Nb exhibit a synergistically increased OSC.

In embodiments, compositions have a PRT (peak reduction temperature) which is reduced by approximately 0° C. to 300° C., compared to an undoped composition comprising cerium, zirconium, lanthanum, and neodymium. PRT corresponds to the reduction of surface or bulk oxygen. Thus, a lower PRT indicates that the sample is more easily reducible, which improves redox performance.

In embodiments, the compositions disclosed herein have a PRT (peak reduction temperature) which is reduced by about 0 to 210° C., compared to an undoped composition comprising cerium, zirconium, lanthanum, and neodymium. In certain embodiments, compositions comprising cerium, zirconium, lanthanum, and neodymium doped with In and Nb exhibit a PRT which is lowered by about 250° C.

In other embodiments, the compositions disclosed herein have a H₂-TPR profile having at least two maxima and the maxima are at a lower temperature compared to an undoped composition comprising cerium, zirconium, lanthanum, and neodymium. The H₂-TPR profile shows the maxima, which corresponds to PRT of the composition. The H₂ consumption calculated using this profile would determine the OSC properties of the composition. A higher H₂ consumption indicates higher oxygen storage and release properties.

In certain embodiments, the compositions disclosed herein after air aging at 1000° C. for hours in an oxidizing environment exhibit X-ray diffractograms that are devoid of extraneous peaks other than those of the cubic or tetragonal phases. In other embodiments, the compositions disclosed herein after air aging at 1000° C. for 10 hours in an oxidizing environment exhibit X-ray diffractograms that are devoid of extraneous peaks other than those of the cubic or tetragonal or intermediate martensitic phases.

### Comparative Example 1: Synthesis of ZrO₂/La₂O₃/Nd₂O₃/CeO₂ (with No Dopant)

The following was done:
1) A Zr/La/Nd nitrate precursor solution of appropriate relative component concentrations was weighed and placed in a beaker.
2) Appropriate amount of ceric ammonium nitrate (CAN) solid was weighed and dissolved in deionized water.
3) The CAN solution was added to the Zr/La/Nd mixture and stirred for one minute. Stirring was carried out by way of a magnetic stirring pan and magnetic stir bar.
4) The CeZrLaNd mixture was diluted to a final volume of 1 liter to give an oxide equivalent concentration of 100 g/L. The mixture was stirred for five minutes. The pH was about the temperature was about 30 degrees Celsius.
5) A 1.5 liter, 4.5M aqueous ammonia was prepared separately.
6) 50 g of lauric acid was weighed, added to the aqueous ammonia solution, and was completely dissolved by stirring for five minutes.
7) The final pH of the ammonia water/lauric acid solution was about 10.5-11.0 and the temperature was about 30 degrees Celsius.
8) After the stirring was started, the CeZrLaNd mixture was added to the ammonia/lauric acid solution. The CeZrLaNd mixture was added over a period of about 4 minutes. After the addition was completed, stirring was continued for one hour. After one hour, the pH was about 9.5-10.0, and the temperature was about 25 degrees Celsius.
9) The precipitates were washed with deionized water. The wash-water conductivity was less than 8 mS/cm.
10) Water was removed by vacuum filtration to obtain a wetcake
11) The wetcake was calcined at 750° C. for five hours.

### Example 2: Synthesis of ZrO₂/La₂O₃/Nd₂O₃/CeO₂ with Sn and Nb Dopants

The following was done:
1) A Zr/La/Nd nitrate precursor solution of appropriate relative component concentrations was weighed and placed in a beaker.
2) Appropriate amount of ceric ammonium nitrate (CAN) solid was weighed and dissolved in deionized water.
3) Tin oxalate and ammonium oxalate solids were weighed and dissolved completely in approximately 50 mL of deionized water
4) Niobium ammonium oxalate solid was weighed and dissolved completely in approximately 50 mL of deionized water.
5) The CAN solution was added to the Zr/La/Nd mixture and stirred for one minute. The Sn oxalate solution was added to the Ce/Zr/La/Nd mixture and stirred for one minute. The Nb solution was added last. Stirring was carried out by way of a magnetic stirring pan and magnetic stir bar.
6) The CeZrLaNdSnNb mixture was diluted to a final volume of 1 liter to give an equivalent oxide concentration of 100 g/L. The mixture was stirred for five minutes. The pH was about 0.40-0.60; the temperature was about 30 degrees Celsius.
7) A 1.5 liter, 4.5M aqueous ammonia was prepared separately.
8) 50 g of lauric acid was weighed and added to aqueous ammonia solution, and was completely dissolved under stirring for five minutes.
9) The final pH of the ammonia water/lauric acid was about 10.5-11.0 and the temperature was about 30 degrees Celsius.
10) After the stirring was started, the CeZrLaNdSnNb mixture was added to the ammonia water. The CeZrLaNdSnNb mixture was added over a period of about 4 minutes. After the addition was completed, stirring was continued for one hour. After one hour, the pH was about 9.5-10.0, and the temperature was about 25 degrees Celsius.
11) The precipitates were then washed with deionized water to a wash-water conductivity of less than 8 mS/cm.
12) Water was removed by vacuum filtration to obtain a wetcake, and
13) The wetcake was calcined at 750° C. for five hours.

### Example 3: Synthesis of ZrO₂/La₂O₃/Nd₂O₃/CeO₂ with Sn and Ba Dopants

Steps 1 to 3 of Example 2 were followed and then the following steps were done:
4) Barium acetate solid was weighed and dissolved completely in approximately 50 mL of deionized water.
5) The CAN solution was added to the Zr/La/Nd mixture and stirred for one minute. The Sn oxalate solution was added to the Ce/Zr/La/Nd mixture and stirred for one minute. The Ba solution was added last. Stirring was carried out by way of a magnetic stirring pan and magnetic stir bar.
6) The CeZrLaNdSnBa mixture was diluted to a final volume of 1 liter to give an equivalent oxide concentration of 100 g/L. The mixture was stirred for five minutes. The pH was about 0.40-0.60; the temperature was about 30 degrees Celsius. The remainder of 7-13 steps were the same as those of Example 2.

### Example 4: Synthesis of ZrO₂/La₂O₃/Nd₂O₃/CeO₂ with Sn and Fe Dopants

Steps 1 to 3 of Example 2 were followed and then the following steps were done:
4) Ammonium iron (III) citrate solid was weighed and dissolved completely in approximately 50 mL of deionized water.
5) The CAN solution was added to the Zr/La/Nd mixture and stirred for one minute. The Sn oxalate solution was added to the Ce/Zr/La/Nd mixture and stirred for one minute. The Fe solution was added last. Stirring was carried out by way of a magnetic stirring pan and magnetic stir bar.
6) The CeZrLaNdSnFe mixture was diluted to a final volume of 1 liter to give an oxide concentration of 100 g/L. The mixture was stirred for five minutes. The pH was about 0.40-0.60; the temperature was about 30 degrees Celsius. The remainder of 7-13 steps were the same as those of Example 2.

### Example 5: Hz-Consumption by Temperature Programmed Reduction (TPR) of Samples

A 50 mg-200 mg sample was weighed into a quartz tube with quartz wool at the bottom. Then the quartz tube containing sample was secured to the furnace of the measuring device (Micromeritics AutoChem II 2920 Automated Catalyst Characterization System). 5% Hydrogen in Argon (v/v) was used as reducing gas with a flow rate of 30 mL/min. The temperature program of the instrument was as follows:
1) The thermal conductivity detector of the instrument were calibrated as per the instrument manufacturer's instructions given in the operations manual.
2) During the first cycle of the TPR run, the sample temperature was increased from ambient to 1000° C. with a ramp rate of 13° C./min under 5% H₂ in Ar.
3) Following the first TPR cycle, the gas flow was changed to 10% Oxygen in Helium at with a flow rate of 30 mL/min and the sample was cooled to 45° C.
4) The second cycle TPR was done under the same conditions as those of (2).
   During the program, the temperature of the sample was measured by a thermocouple placed in the quartz tube directly above the sample.

The H₂ consumption during the TPR phase was calculated based on the calibration of the TCD done in step (1) and the H₂ consumption in step (4), taking into account baseline correction. Baseline was determined by this method. For the ascending slope of the signal peak, point A is identified when the tangent line has slope zero. For the descending slope of the signal peak, point B is identified when the tangent line has slope zero. A straight line is drawn connecting point A and B. This straight line is designated as the baseline for the H₂-TPR spectrum.

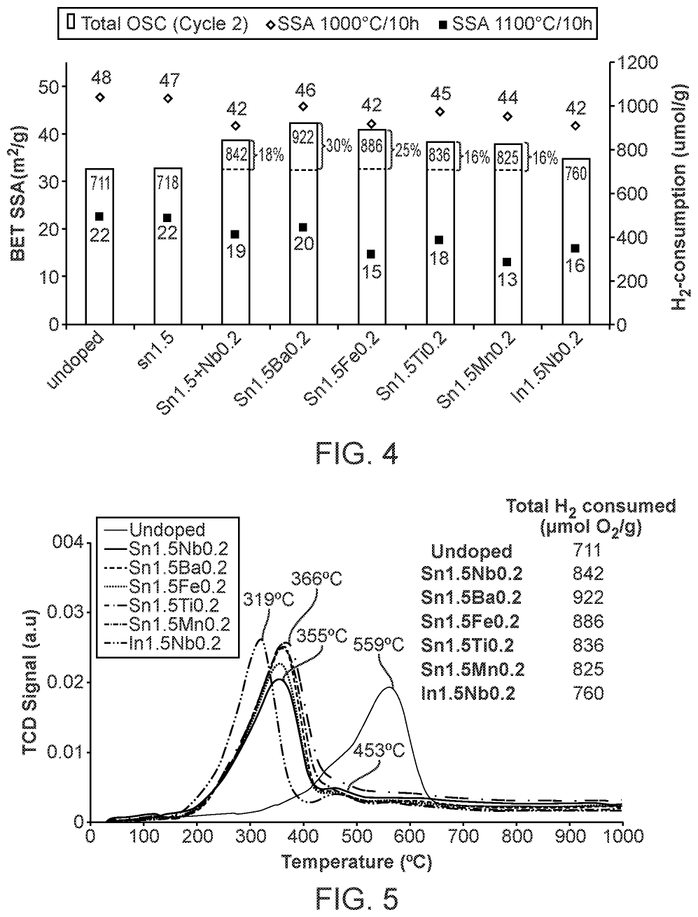

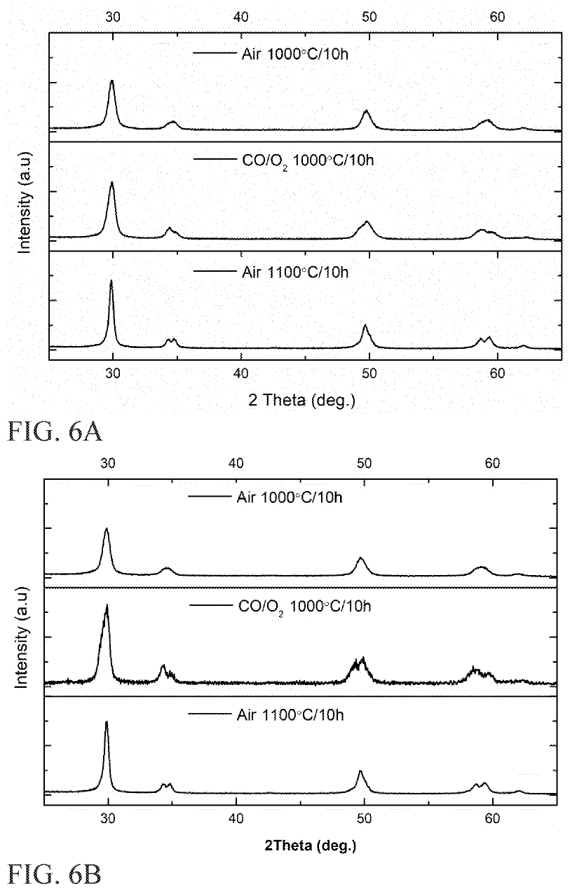

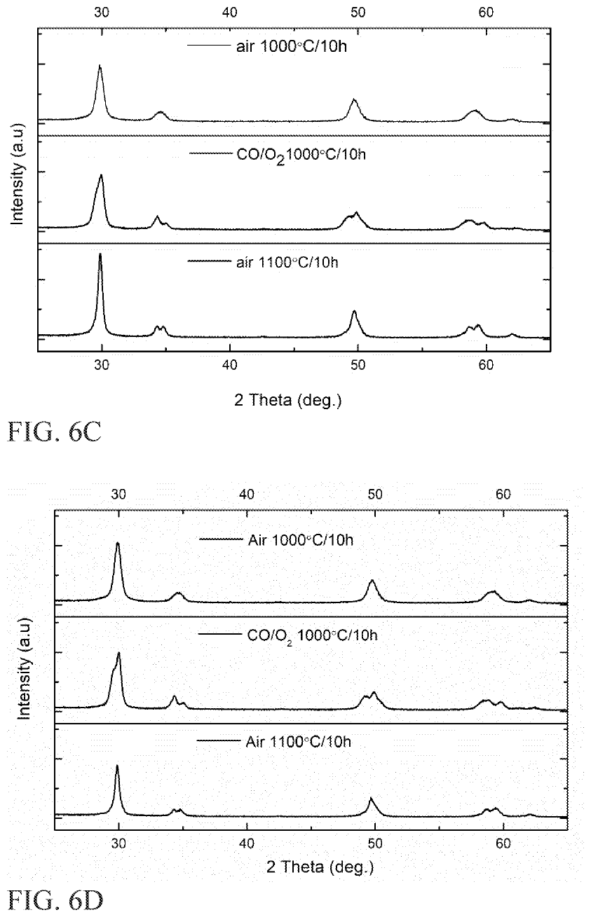

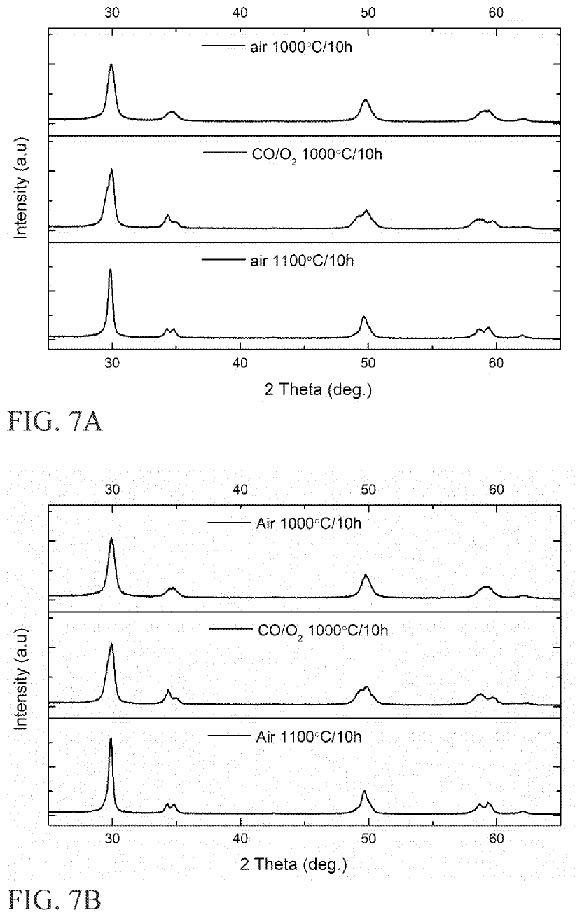

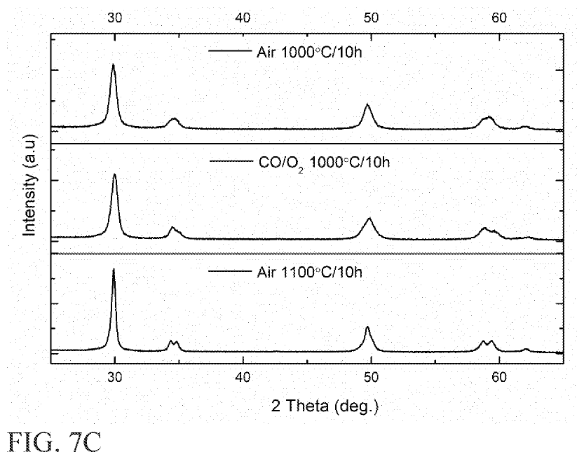

The TPR results are given in FIGS. 3 and 5.

### Example 6: Incorporating Mixed Oxide Materials Including ZrO₂ and CeO₂ with Dopants into a Catalyst or Catalyst Support

The mixed oxide materials comprising cerium, zirconium, and OSC enhancing dopants as described herein can be utilized as major components in a catalyst or catalyst support to be incorporated into automobile exhaust system. Introduction of dopants into the cerium zirconium lattice greatly enhances and facilitates oxygen mobility. These mixed oxide materials as disclosed herein possess high oxygen storage and release characteristics.

To make the catalyst or catalyst support, the cerium and zirconium doped mixed oxide powder is mixed with a refractory inorganic oxide, such as aluminum oxide, silicon oxide or titanium oxide, in water to form a powder slurry. Then, precious metals such as palladium, rhodium or platinum, and other additives such as stabilizers, promoters and binders are added to the oxide slurry to obtain a washcoat. This washcoat slurry may then be coated onto a carrier, such as a ceramic monolithic honeycomb structure to prepare a catalyst for automobile exhaust gas purification.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the compositions and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

1. A composition comprising cerium, zirconium, lanthanum, and neodymium, and a dopant selected from the group consisting of Ti, Mn, Fe, Co, Cu, Zn, Ga, Ge, Ta, W, Mo, Nb, In, Sn, Ba, and mixtures thereof.

2. A composition consisting essentially of cerium, zirconium, lanthanum, and neodymium, and a dopant selected from the group consisting of Ti, Mn, Fe, Co, Cu, Zn, Ga, Ge, Ta, W, Mo, Nb, In, Sn, Ba, and mixtures thereof.

3. The composition of claim 1, wherein the composition contains two dopants.

4. A composition consisting of cerium, zirconium, lanthanum, neodymium, one or more dopant elements, and less than 0.5% by weight other elements, wherein the dopant elements are selected from the group consisting of Ti, Mn, Fe, Co, Cu, Zn, Ga, Ge, Ta, W, Mo, Nb, In, Sn, Ba, and mixtures thereof and wherein the other elements are any elements that are not Ce, Zr, La, Nd, Ti, Mn, Fe, Co, Cu, Zn, Ga, Ge, Ta, W, Mo, Nb, In, Sn, or Ba.

5. The composition of claim 1, wherein the ratio of Ce/Zr/La/Nd is approximately 15-25 wt %/65-75 wt %/0.5-3 wt %/2-8 wt % on an equivalent oxide basis.

6. The composition of claim 1, wherein the dopant(s) are present in the composition in an amount of about 0.1-10 wt % of composition.

7. The composition of claim 1, wherein the composition contains one, two, three, or four dopants.

8. The composition of any one of claim 1, wherein the dopant is Sn and Nb.

9. The composition of claim 8, wherein the ratio of Sn to Nb is about 1.5 to 0.2.

10. The composition of claim 1, wherein the dopant is Sn and Fe, Sn and Ba, or Nb and In.

11. The composition of claim 1, wherein the composition has a surface area after aging at 1000° C. for 10 hours in an oxidizing environment which is maintained in the range of about 50% to 100% or more of that for the undoped composition comprising cerium, zirconium, lanthanum, and neodymium.

12. The composition of claim 1, wherein the composition has a surface area after aging at 1100° C. for 10 hours in an oxidizing environment which is maintained in the range of about 60% to 100% or more of that for an undoped composition comprising cerium, zirconium, lanthanum, and neodymium.

13. The composition of claim 1, wherein the composition has an OSC after aging at 1000° C. for 10 hours in an oxidizing environment which is improved by about 1 to 50%, compared to an undoped composition comprising cerium, zirconium, lanthanum, and neodymium.

14. The composition of claim 1, wherein the composition has an OSC after aging at 1000° C. for 10 hours in an oxidizing environment which is improved by about 1 to 35%, compared to an undoped composition comprising cerium, zirconium, lanthanum, and neodymium.

15. The composition of any one of claim 1, wherein the composition has an OSC after aging at 1000° C. for 10 hours in an oxidizing environment which is improved by about 10 to 30%, compared to an undoped composition comprising cerium, zirconium, lanthanum, and neodymium.

16. The composition of claim 1, wherein the composition has a PRT (peak reduction temperature) which is reduced by about 0° C. to 300° C., compared to an undoped composition comprising cerium, zirconium, lanthanum, and neodymium.

17. The composition of claim 1, wherein the composition has a PRT (peak reduction temperature) which is reduced by about 0° C. to 210° C., compared to an undoped composition comprising cerium, zirconium, lanthanum, and neodymium.

18. The composition of claim 1, wherein the composition has a H₂-TPR profile having at least two maxima and the maxima are at a lower temperature compared to an undoped composition comprising cerium, zirconium, lanthanum, and neodymium.

19. The composition of claim 1, wherein the composition after air aging at 1000° C. for 10 hours in an oxidizing environment exhibit X-ray diffractogram that is devoid of extraneous peaks other than those of the cubic or tetragonal or intermediate martensitic phases.

20. A process of producing a composition comprising cerium, zirconium, lanthanum, and neodymium and dopant comprising the steps of:
(a) mixing Zr, La, and Nd salts, Ce salts, and dopant X in water, to provide a mixture;
(b) adding the mixture to an ammonia water solution to form a precipitate; and
(c) calcining the precipitate,
wherein the dopant X is selected from the group consisting of Ti, Mn, Fe, Co, Cu, Zn, Ga, Ge, Ta, W, Mo, Nb, In, Sn, Ba, and mixtures thereof.

21. The process of claim 20, wherein the Zr, La, Nd, and Ce salts are nitrates.

22. The process of claim 20, wherein dopant X is two elements selected from Ti, Mn, Fe, Co, Cu, Zn, Ga, Ge, Ta, W, Mo, Nb, In, Sn and Ba.

23. The process of claim 20, wherein a first dopant X is introduced by a compound selected from the group consisting of SnCl₄ anhydrous (fuming), SnCl₄·5H₂O, SnCl₂·2H₂O, SnC₂O₄, In(NO₃)₃, and mixtures thereof and a second dopant X is introduced by a compound selected the group consisting of NbCl₅, Nb(O)(C₂O₄)₂NH₄, Ba(CH₃COO)₂, ammonium iron (III) citrate, ammonium iron (III) oxalate, iron (II) oxalate, FeCl₂, FeCl₃, iron (III) nitrate, iron (III) acetylacetonate, manganese (II) acetate, ammonium titanyl (IV) oxalate, and mixtures thereof.

24. The process of claim 22, wherein dopant X is Sn and Nb, Sn and Ba, Sn and Fe, or Nb and In.

25. The process of claim 21, wherein in step (a) the ceric nitrate in water is added to the Zr, La, and Nd nitrates; a first dopant X is added, and then a second dopant X is added to provide the mixture.

26. The process of claim 20, wherein the mixture of step (a) has an oxide concentration of approximately 20 g/L to 150 g/L.

27. The process of claim 20, wherein the calcining is conducted at a temperature ranging from about 400° C. to 1100° C. and for from about 0.25 to 24 hours.

28. A composition made by the process of claim 20.

29. (canceled)
